(19) United States
(12) Patent Application Publication
(10) Pub. No.: US 2025/0246821 A1
(43) Pub. Date: Jul. 31, 2025

(54) ELECTRONIC DEVICE AND METHOD FOR IDENTIFYING POLARIZED WAVE

(71) Applicant: SAMSUNG ELECTRONICS CO., LTD., Suwon-si (KR)

(72) Inventors: Janghoon HAN, Suwon-si (KR); Daehee PARK, Suwon-si (KR)

(21) Appl. No.: 19/185,244

(22) Filed: Apr. 22, 2025

Related U.S. Application Data
(63) Continuation of application No. PCT/KR2023/015469, filed on Oct. 6, 2023.

(30) Foreign Application Priority Data
Oct. 30, 2022 (KR) 10-2022-0141935
Dec. 2, 2022 (KR) 10-2022-0166713

(51) Int. Cl. H01Q 25/00; H01Q 3/26; H04B 1/3827; H04B 7/0426

(52) U.S. Cl. CPC H01Q 25/001; H01Q 3/2611; H04B 1/3838; H04B 7/043

(57) ABSTRACT

An electronic device includes: at least one processor; a first antenna module including a plurality of first antenna elements; and a second antenna module including a plurality of second antenna elements. Each of the plurality of first antenna elements transmits a signal of a first polarized wave or a second polarized wave that is different from the first polarized wave. Each of the plurality of second antenna elements transmits a signal of the first polarized wave or the second polarized wave. The at least one processor identifies: direction information of a base station; the first antenna module and the second antenna module based on the direction information; a beam ID based on the direction information of the base station; and a polarization mode corresponding to either a first polarization mode or a second polarization mode based on the direction information of the base station.

### CROSS-REFERENCE

This application is a continuation application, claiming priority under § 365 (c), of International Patent Application No. PCT/KR2023/015469, filed on Oct. 6, 2023, which is based on and claims the benefit of Korean patent application number 10-2022-0141935, filed on Oct. 30, 2022, in the Korean Intellectual Property Office, and of Korean patent application number 10-2022-0166713, filed on Dec. 2, 2022, in the Korean Intellectual Property Office, the disclosure of each of which is incorporated by reference herein in its entirety.

### BACKGROUND

### (1) Field

Various embodiments relate to an electronic device and a method for identifying polarized wave.

### (2) Description of the Related Art

According to development of wireless communication technology, an electronic device (e.g., an electronic device for communication) is being used commonly in daily life, content usage due to this is increasing exponentially. Due to a rapid increase in the content usage, a network capacity is gradually reaching its limit, and after commercialization of a 4th generation (4G) communication system, a communication system (e.g., 5th generation (5G), a pre-5G communication system, or a new radio (NR)) that transmit and/or receive a signal using a frequency in a high-frequency (e.g., mmWave) band (e.g., approximately 1.8 GHZ, approximately 3 GHz to approximately 300 GHz bands) are being studied to meet an increasing demand for wireless data traffic. In order to achieve a high data transmission rate, a 5G communication system is considered to be implemented in an ultra-high frequency band. In order to mitigate a path loss of a radio wave in the ultra-high frequency band and increase a transmission distance of the radio wave, in the 5G communication system, beamforming, a massive multi-input multi-output (massive MIMO), a full dimensional MIMO (FD-MIMO), an array antenna, analog beam-forming, and large scale antenna technologies are being discussed.

### SUMMARY

In embodiments, an electronic device is provided. The electronic device may include at least one processor, a first antenna module including a plurality of first antenna elements, and a second antenna module including a plurality of second antenna elements. Each of the plurality of first antenna elements may be configured to transmit a signal of a first polarization or a second polarization different from the first polarization. Each of the plurality of second antenna elements may be configured to transmit a signal of the first polarization or the second polarization. The at least one processor may be configured to identify direction information of a base station. The at least one processor may be configured to identify, based on the direction information of the base station, one antenna module among the first antenna module and the second antenna module. The at least one processor may be configured to identify, based on the direction information of the base station, a beam identifier (ID). The at least one processor may be configured to identify, based on the direction information of the base station, a polarization mode as one of a first polarization mode or a second polarization mode. The at least one processor may be configured to transmit a signal based on the identified antenna module, a communication path corresponding to the identified polarization mode, and the beam ID.

In embodiments, an electronic device is provided. The electronic device may include at least one processor, a first antenna module including a plurality of first antenna elements, and a second antenna module including a plurality of second antenna elements. Each of the plurality of first antenna elements may be configured to receive a signal of a first polarization or a second polarization different from the first polarization. Each of the plurality of second antenna elements may be configured to receive a signal of the first polarization or the second polarization. The at least one processor may be configured to identify direction information of a base station. The at least one processor may be configured to identify, based on the direction information of the base station, one antenna module among the first antenna module and the second antenna module. The at least one processor may be configured to identify, based on the direction information of the base station, a beam ID. The at least one processor may be configured to identify, based on the direction information of the base station, a polarization mode as one of a first polarization mode or a second polarization mode. The at least one processor may be configured to receive a signal based on the identified antenna module, a communication path corresponding to the identified polarization mode, and the beam ID.

In embodiments, a method performed by an electronic device is provided. The method may include identifying direction information of a base station. The method may include identifying, based on the direction information of the base station, an antenna module among a first antenna module and a second antenna module of the electronic device. The method may include identifying, based on the direction information of the base station, a beam ID of the antenna module. The method may include identifying, based on the direction information of the base station, a polarization mode of the antenna module as one of a first polarization mode or a second polarization mode. The method may include transmitting, by the antenna module, a signal based on the identified antenna module, a communication path corresponding to the identified polarization mode, and the beam ID.

In embodiments, a method performed by an electronic device 101 is provided. The method may include identifying direction information of a base station, and identifying, based on the direction information of the base station, an antenna module among a first antenna module and a second antenna module of the electronic device. The method may include identifying, based on the direction information of the base station, a beam ID of the antenna module. The method may include identifying, based on the direction information of the base station, a polarization mode of the antenna module as one of a first polarization mode or a second polarization mode. The method may include receiving, by the antenna module, a signal based on the identified antenna module, a communication path corresponding to the identified polarization mode, and the beam ID.

### BRIEF DESCRIPTION OF THE DRAWINGS

FIG. 1 is a block diagram of an electronic device in a network environment, according to embodiments.

FIG. 2 is a block diagram of an electronic device for supporting legacy network communication and 5G network communication according to embodiments.

FIG. 3 illustrates an example of a structure of a third antenna module according to embodiments.

FIG. 4 illustrates an example of a plurality of antenna elements in an antenna module according to embodiments.

FIG. 5 illustrates an example of a beam formed according to an attachment position of an antenna module according to embodiments.

FIG. 6 illustrates an example of a configuration of an electronic device for receiving a signal through an antenna, according to embodiments.

FIG. 7 illustrates an example of a strength of a beam transmitted based on a polarization mode according to a mounting method of antenna elements according to embodiments.

FIG. 8 illustrates an example of identification of an antenna module, a beam identifier (ID), and a polarization mode according to direction information of a base station, according to embodiments.

FIG. 9 is a flow chart of an operation of an electronic device for receiving a signal based on direction information of a base station and a polarization mode, according to embodiments.

FIG. 10 is a flow chart of an operation of an electronic device for selecting an antenna to be used based on a mode of the electronic device, according to embodiments.

FIG. 11 illustrates an effect according to a change in a polarization mode of an antenna.

FIG. 12 illustrates an example of a coordinate that is a reference of direction information of a base station.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Terms used in the present disclosure are used only to describe a specific embodiment, and may not be intended to limit a range of another embodiment. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

In various embodiments of the present disclosure described below, a hardware approach will be described as an example. However, since the various embodiments of the present disclosure include technology that uses both hardware and software, the various embodiments of the present disclosure do not exclude a software-based approach.

Terms referring to an antenna element (e.g., an antenna element, an antenna component, and a set of conductive members), terms referring to a specified value (a reference value, a threshold value), and the like used in the following description are exemplified for convenience of description. Therefore, the present disclosure is not limited to terms described below, and another term having an equivalent technical meaning may be used. In addition, terms such as ‘ . . . part’, ‘ . . . device’, ‘ . . . material’, and ‘ . . . body’, and the like used below may mean at least one shape structure or may mean a unit processing a function.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ refer to including at least one of ‘C’ or ‘D’, that is, {′C′, ‘D’, and ‘C’ and ‘D’}.

Hereinafter, various embodiments disclosed in the present document will be described with reference to the accompanying drawing. For convenience of illustration and description, components illustrated in the drawing may be exaggerated or reduced in their sizes, and the present invention is not necessarily limited to what is illustrated.

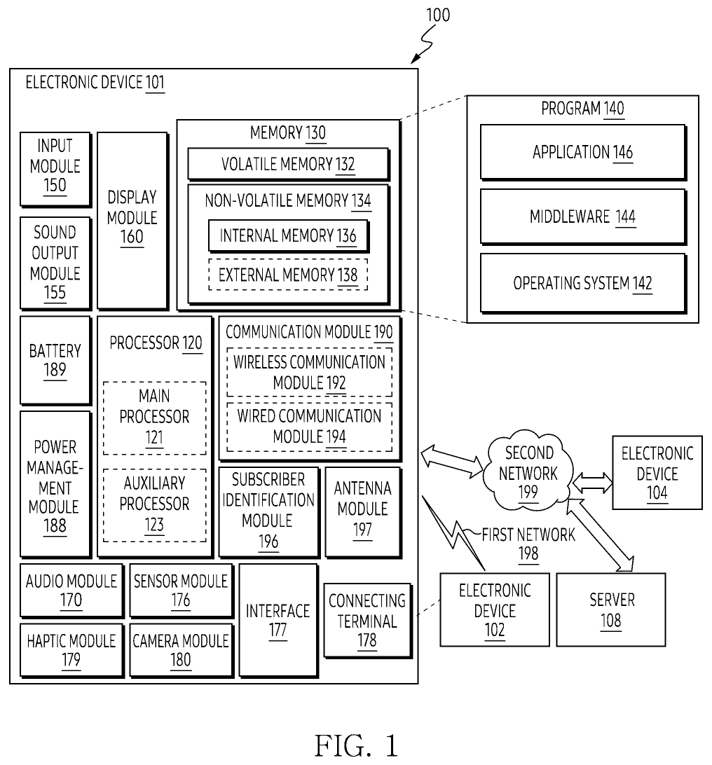

FIG. 1 is a block diagram of an electronic device in a network environment, according to embodiments.

Referring to FIG. 1, an embodiment of the electronic device 101 in the network environment 100 may communicate with an electronic device 102 via a first network 198 (e.g., a short-range wireless communication network), or with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, in an embodiment where the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display (a display device or a display panel), a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module).

A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mM TC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type from, the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

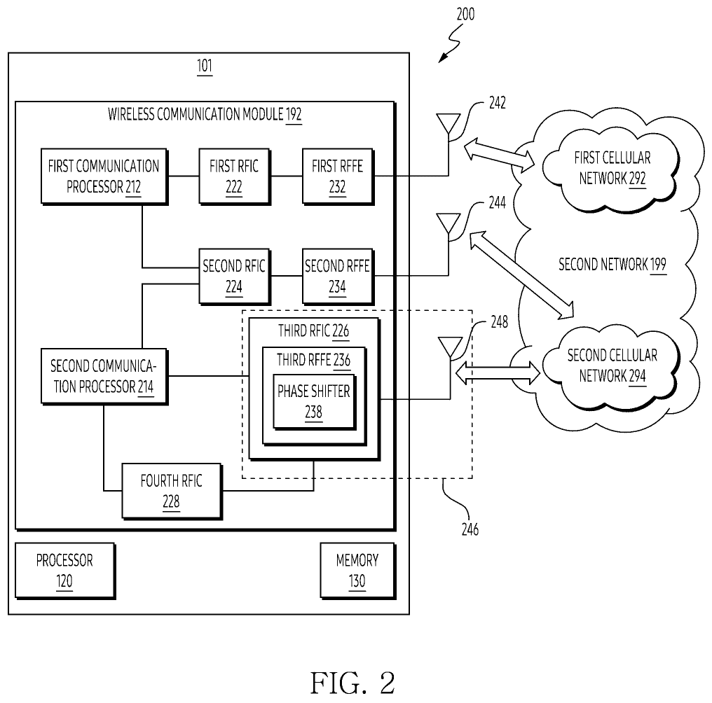

FIG. 2 is a block diagram of an electronic device for supporting legacy network communication and 5G network communication according to embodiments.

Referring to FIG. 2, an embodiment of the electronic device 101 may include a first communication processor 212, a second communication processor 214, a first radio frequency integrated circuit (RFIC) 222, a second RFIC 224, and a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and memory 130. A second network 199 may include a first cellular network 292 and a second cellular network 294. According to another embodiment, the electronic device 101 may further include at least one of the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may constitute at least a part of a wireless communication module 192. According to another embodiment, the fourth RFIC 228 may be omitted or may be included as a part of the third RFIC 226.

The first communication processor 212 may support the establishment of a communication channel of a band to be used for wireless communication with the first cellular network 292 and legacy network communication through the established communication channel. According to various embodiments, the first cellular network 292 may be a legacy network including a 2nd generation (2G), 3rd generation (3G), 4th generation (4G), and/or long-term evolution (LTE) network. The second communication processor 214 may support the establishment of a communication channel corresponding to a specified band (e.g., approximately 6 GHz to 60 GHZ) among bands to be used for wireless communication with the second cellular network 294, and 5G network communication through the established communication channel. According to various embodiments, the second cellular network 294 may be a 5G network defined by 3rd generation partnership project (3GPP). Additionally, according to an embodiment, the first communication processor 212 or the second communication processor 214 may support the establishment of a communication channel corresponding to another specified band (e.g., approximately 6 GHz or less) among bands to be used for wireless communication with the second cellular network 294, and 5G network communication through the established communication channel. According to an embodiment, the first communication processor 212 and the second communication processor 214 may be implemented in a single chip or a single package. According to various embodiments, the first communication processor 212 or the second communication processor 214 may be formed with the processor 120, the auxiliary processor 123 of FIG. 1, or the communication module 190 in a single chip or a single package.

Upon transmission, the first RFIC 222 may convert a baseband signal generated by the first communication processor 212 into a radio frequency (RF) signal of approximately 700 MHz to approximately 3 GHz used in the first cellular network 292 (e.g., a legacy network). Upon reception, an RF signal may be obtained from the first cellular network 292 (e.g., a legacy network) through an antenna (e.g., the first antenna module 242), and may be preprocessed through an RFFE (e.g., the first RFFE 232). The first RFIC 222 may convert the preprocessed RF signal into a baseband signal to be processed by the first communication processor 212.

Upon transmission, the second RFIC 224 may convert a baseband signal generated by the first communication processor 212 or the second communication processor 214 into an RF signal (hereinafter, referred to as a 5G Sub6 RF signal) of the Sub6 band (e.g., approximately 6 GHz or less) used in the second cellular network 294 (e.g., the 5G network). Upon reception, a 5G Sub6 RF signal may be obtained from the second cellular network 294 (e.g., the 5G network) through an antenna (e.g., the second antenna module 244), and may be preprocessed through an RFFE (e.g., the second RFFE 234). The second RFIC 224 may convert the preprocessed 5G Sub6 RF signal into a baseband signal to be processed by a corresponding one of the first communication processor 212 or the second communication processor 214.

The third RFIC 226 may convert a baseband signal generated by the second communication processor 214 into an RF signal (hereinafter, referred to as a 5G Above6 RF signal) of the 5G Above6 band (e.g., approximately 6 GHz to approximately 60 GHz) to be used in the second cellular network 294 (e.g., the 5G network). Upon reception, a 5G Above6 RF signal may be obtained from the second cellular network 294 (e.g., the 5G network) through an antenna (e.g., the antenna 248), and may be preprocessed through the third RFFE 236. For example, the third RFFE 236 may perform preprocessing of the signal by using a phase shifter 238. The third RFIC 226 may convert the preprocessed 5G Above6 RF signal into a baseband signal to be processed by the second communication processor 214. According to an embodiment, the third RFFE 236 may be formed as a part of the third RFIC 226.

According to an embodiment, the electronic device 101 may include the fourth RFIC 228 separately from or at least as a part of the third RFIC 226. In this case, the fourth RFIC 228 may convert the baseband signal generated by the second communication processor 214 into an RF signal (hereinafter, referred to as an intermediate frequency (IF) signal) of an intermediate frequency band (e.g., approximately 9 GHz to approximately 11 GHZ), and then transmit the IF signal to the third RFIC 226. The third RFIC 226 may convert the IF signal into a 5G Above6 RF signal. Upon reception, a 5G Above6 RF signal may be received from the second cellular network 294 (e.g., the 5G network) through an antenna (e.g., the antenna 248), and may be converted into an IF signal by the third RFIC 226. The fourth RFIC 228 may convert the IF signal into the baseband signal to be processed by the second communication processor 214.

According to an embodiment, the first RFIC 222 and the second RFIC 224 may be implemented as a single chip or defined by at least a part of a single package. According to an embodiment, the first RFFE 232 and the second RFFE 234 may be implemented as a single chip or defined by at least a part of a single package. According to an embodiment, at least one of the first antenna module 242 or the second antenna module 244 may be omitted or combined with another antenna module to process RF signals of a plurality of corresponding bands.

According to an embodiment, the third RFIC 226 and the antenna 248 may be disposed on the same substrate to form a third antenna module 246. In an embodiment, for example, the wireless communication module 192 or the processor 120 may be disposed on a first substrate (e.g., a main PCB). In such an embodiment, the third RFIC 226 may be disposed in a partial region (e.g., the lower surface) of a second substrate (e.g., a sub PCB) separate from the first substrate, and the antenna 248 may be disposed in another partial region (e.g., the upper surface) to form the third antenna module 246. According to an embodiment, the antenna 248 may include, for example, an antenna array that may be used for beamforming. By disposing the third RFIC 226 and the antenna 248 on a same substrate, it is possible to reduce the length of the transmission line therebetween. This, for example, may reduce the loss (e.g., attenuation) of a signal in a high frequency band (e.g., approximately 6 GHz to approximately 60 GHZ) used for 5G network communication by the transmission line. Accordingly, the electronic device 101 may improve the quality or speed of communication with the second cellular network 294 (e.g., the 5G network).

The second cellular network 294 (e.g., the 5G network) may be operated independently of (e.g., Stand-Alone (SA)) or operated to be connected to (e.g., Non-Stand Alone (NSA)) the first cellular network 292 (e.g., the legacy network). In an embodiment, for example, in the 5G network, there may be only an access network (e.g., 5G radio access network (RAN) or next-generation RAN (NG RAN)) and no core network (e.g., next-generation core (NGC)). In such an embodiment, after accessing the access network of the 5G network, the electronic device 101 may access an external network (e.g., the Internet) under the control of a core network (e.g., evolved packed core (EPC)) of the legacy network. Protocol information for communication with the legacy network (e.g., LTE protocol information) or protocol information for communication with the 5G network (e.g., New Radio (NR) protocol information) may be stored in the memory 230 and may be accessed by other components (e.g., the processor 120, the first communication processor 212, or the second communication processor 214).

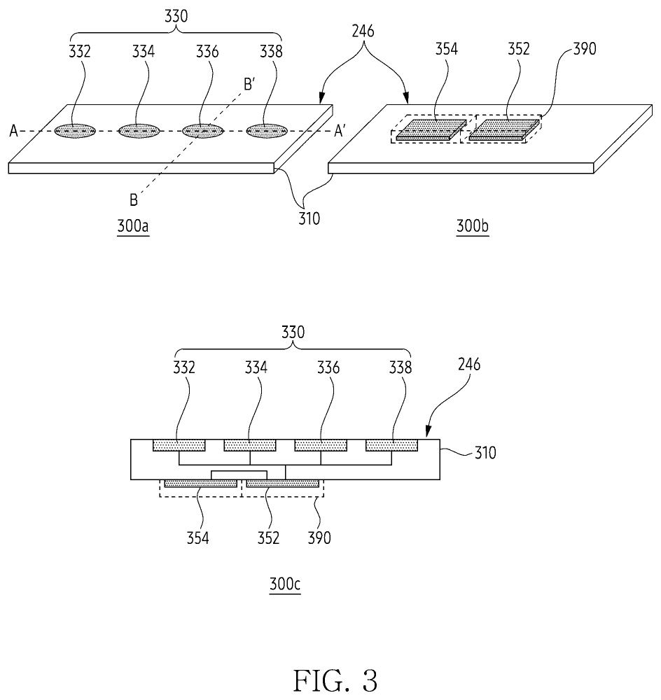

FIG. 3 illustrates an example of a structure of a third antenna module (e.g., the third antenna module 246 of FIG. 2) according to embodiments. 300a of FIG. 3 is a perspective view of the third antenna module 246 viewed from a side, and 300b of FIG. 3 is a perspective view of the third antenna module 246 viewed from another side. 300c of FIG. 3 is a cross-sectional view of the third antenna module 246 cut along line A-A′.

Referring to FIG. 3, in an embodiment, the third antenna module 246 may include a printed circuit board 310, an antenna array 330, a radio frequency integrate circuit (RFIC) 352, a power manage integrate circuit (PMIC) 354, and a module interface (not illustrated). Selectively, the third antenna module 246 may further include a shielding member 390. In other embodiments, at least one of the above-mentioned components may be omitted, or at least two of the components may be integrally formed as a single unitary indivisible part.

The printed circuit board 310 may include a plurality of conductive layers and a plurality of non-conductive layers stacked alternately with the conductive layers. The printed circuit board 310 may provide an electrical connection between the printed circuit board 310 and/or various electronic components disposed outside using wires and conductive vias formed in the conductive layer.

The antenna array 330 (e.g., the antenna 248 of FIG. 2) may include a plurality of antenna elements 332, 334, 336, or 338 disposed to form a directional beam. The antenna elements may be disposed or formed in a first surface of the printed circuit board 310 as illustrated in FIG. 3. According to another embodiment, the antenna array 330 may be formed inside the printed circuit board 310. According to embodiments, the antenna array 330 may include a plurality of antenna arrays (e.g., a dipole antenna array, and/or a patch antenna array) of a same shape or type as each other or different shapes or types from each other.

The RFIC 352 (e.g., the third RFIC 226 of FIG. 2) may be disposed in another area (e.g., a second surface opposite the first surface) of the printed circuit board 310 spaced apart from the antenna array 330. The RFIC 352 may be configured to process a signal of a selected frequency band transmitted/received through the antenna array 330. According to an embodiment, when transmitting, the RFIC 352 may convert a baseband signal obtained from a communication processor (not illustrated) into an RF signal of a specified band. When receiving, the RFIC 352 may convert the RF signal received through the antenna array 330 into the baseband signal and transmit it to the communication processor.

According to another embodiment, when transmitting, the RFIC 352 may up-convert an IF signal (e.g., approximately 9 GHz to approximately 11 GHZ) obtained from an intermediate frequency integrate circuit (IFIC) (e.g., the fourth RFIC 228 of FIG. 2) into the RF signal of a selected band. When receiving, the RFIC 352 may down-convert the RF signal obtained through the antenna array 330 to convert the RF signal into the IF signal and transmit it to the IFIC.

The PMIC 354 may be disposed in another partial area (e.g., the second surface) of the printed circuit board 310 spaced apart from the antenna array. The PMIC 354 may receive a voltage from a main PCB (not illustrated) and provide power required for various components (e.g., the RFIC 352) on the antenna module.

The shielding member 390 may be disposed on a portion (e.g., the second surface) of the printed circuit board 310 to electromagnetically shield at least one of the RFIC 352 or the PMIC 354. According to an embodiment, the shielding member 390 may include a shield can.

Although not illustrated, in various embodiments, the third antenna module 246 may be electrically connected to another printed circuit board (e.g., a main circuit board) through a module interface. The module interface may include a connection member, for example, a coaxial cable connector, a board to board connector, an interposer, or a flexible printed circuit board (FPCB). Through the connection member, the RFIC 352 and/or PMIC 354 of the third antenna module 246 may be electrically connected to the printed circuit board.

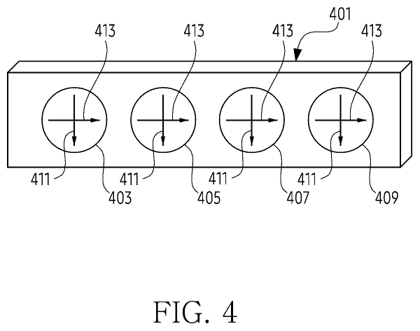

FIG. 4 illustrates an example of a plurality of antenna elements in an antenna module according to embodiments.

Referring to FIG. 4, an embodiment of an antenna module 401 may include a first antenna element portion 403, a second antenna element portion 405, a third antenna element portion 407, and a fourth antenna element portion 409. The antenna element portion (e.g., the first antenna element portion 403, the second antenna element portion 405, the third antenna element portion 407, or the fourth antenna element portion 409) may transmit and receive a beam having a first polarization characteristic based on a first polarization mode. For example, the first polarization may be a vertical (V) polarization 411. For example, the first polarization may be a horizontal (H) polarization 413.

The antenna element portion (e.g., the first antenna element portion 403, the second antenna element portion 405, the third antenna element portion 407, or the fourth antenna element portion 409) may transmit and receive a beam having a second polarization characteristic based on a second polarization mode. A direction of the first polarization and a direction of the second polarization may be substantially perpendicular to each other. For example, in an embodiment where the first polarization is the V polarization 411, the second polarization may be the H polarization 413. For example, in an embodiment where the second polarization is the H polarization 413, the first polarization may be the V polarization 411.

According to an embodiment, the antenna element portion (e.g., the first antenna element portion 403, the second antenna element portion 405, the third antenna element portion 407, or the fourth antenna element portion 409) may include a conductive member. For example, the conductive member may mean a radiator of a patch antenna. The conductive member may be connected to a first feeding unit for providing a signal of the first polarization (e.g., the H polarization 413) and a second feeding unit for providing a signal of the second polarization (e.g., the V polarization 411). According to selection of an electronic device 101, the conductive member may transmit or receive one of the signal of the first polarization or the signal of the second polarization.

According to an embodiment, the antenna element portion (e.g., the first antenna element portion 403, the second antenna element portion 405, the third antenna element portion 407, or the fourth antenna element portion 409) may include a first conductive member and a second conductive member. For example, each of the first conductive member and the second conductive member may mean a radiator of a dipole antenna. The first conductive member may transmit or receive the signal of the first polarization (e.g., the H polarization 413). The second conductive member may transmit or receive the signal of the second polarization (e.g., the V polarization 411). According to selection of (or in response to a selection signal from) the electronic device 101, the conductive member may transmit or receive one of the signal of the first polarization or the signal of the second polarization.

According to an embodiment, the antenna module 401 may be referred to as a 5G mmWave module. At least one processor (e.g., the processor 120 of FIG. 1) may transmit or receive a radio wave in a band having a milli-meter (mm) wavelength through the antenna module 401. As an example, the antenna module 401 may transmit or receive a radio wave of a band of frequency range (FR)2 (e.g., 24.25 GHz to 71.0 GHz) in a 5G new radio (NR) standard. The at least one processor 120 may include a communication processor (CP) (e.g., the auxiliary processor 123 of FIG. 1).

According to an embodiment, the at least one processor 120 may set the electronic device 101 to a multi-antenna mode or a single antenna mode. The at least one processor 120 may perform communication with another electronic device through a plurality of antennas of the electronic device 101 in the multi-antenna mode. For example, the multi-antenna mode may be referred to as a multiple input multiple output (MIMO) mode. According to an embodiment, the at least one processor 120 may perform 2×2 MIMO communication with two antennas of another electronic device through two antennas of the electronic device 101. In order to implement the two antennas, two feeding paths (e.g., a first feeding path for the H polarization and a second feeding path for the V polarization) may be used. For example, a radiator (e.g., the patch antenna) may operate as a first antenna through the first feeding path. The radiator (e.g., the patch antenna) may operate as a second antenna through the second feeding path.

The single antenna mode may be referred to as a single input single output (SISO) mode. The at least one processor 120 may perform communication with another electronic device through a single antenna of the electronic device 101 in the single antenna mode. According to an embodiment, the at least one processor 120 may perform 1×1 SISO communication with one antenna of another electronic device through one antenna of the electronic device 101. For example, a radiator may operate as the one antenna through the first feeding path. For another example, the radiator may operate as the one antenna through the second feeding path. According to an embodiment, the one antenna may correspond to the radiator (e.g., the first antenna element portion 403, the second antenna element portion 405, the third antenna element portion 407, and the fourth antenna element portion 409) according to the first feeding path. According to another embodiment, the one antenna may correspond to the radiator (e.g., the first antenna element portion 403, the second antenna element portion 405, the third antenna element portion 407, and the fourth antenna element portion 409) according to the second feeding path of the radiator.

According to an embodiment, the at least one processor 120 may identify whether network communication quality is less than a threshold (or a reference quality). The at least one processor 120 may set the electronic device 101 to the multi-antenna mode based on identifying (e.g., when it is identified) that the network communication quality is not less than the threshold. The at least one processor 120 may use the first polarization and the second polarization through antenna elements included in one of antenna modules (e.g., a first antenna module and a second antenna module) in the multi-antenna mode. The at least one processor 120 may set the electronic device 101 to the single antenna mode based on identifying (e.g., when it is identified) that the network communication quality (e.g., at least one selected from reference signal received power (RSRP), reference signal received quality (RSRQ), received signal strength indicator (RSSI), signal to interference and noise ratio (SINR), and carrier to interference and noise ratio (CINR)) is less than the threshold. In the single antenna mode, the at least one processor 120 may use the first polarization or the second polarization through the antenna elements included in one of the antenna modules (e.g., the first antenna module and the second antenna module).

The H polarization or the V polarization is illustrated in FIG. 4, but embodiments of the present disclosure are not limited thereto. In another embodiment, a +45 degree and −45 degree polarization may be used as the first and second polarization.

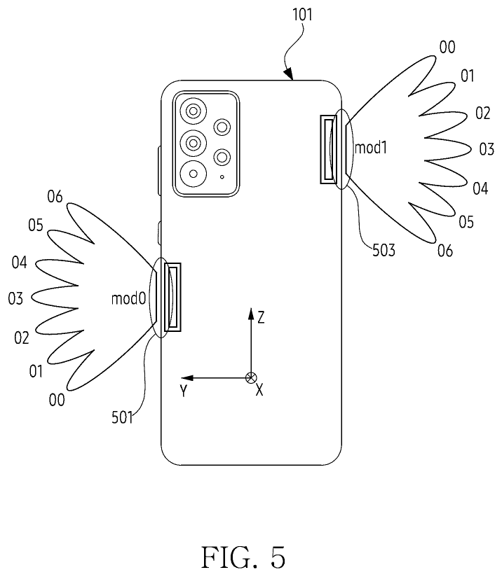

FIG. 5 illustrates an example of a beam formed according to an attachment position of an antenna module according to embodiments.

Referring to FIG. 5, an embodiment of an electronic device 101 may include a first antenna module 501 (module #0 or mod0). The first antenna module 501 may include the first antenna module 501 disposed on a side surface (e.g., a surface facing a +y-axis direction) of the electronic device 101. The electronic device 101 may include a second antenna module 503 (module #1 or mod1). The second antenna module 503 may include the first antenna module 501 disposed on another side surface (e.g., a surface facing a −y-axis direction) of the electronic device 101. The first antenna module 501 may include a plurality of first antenna elements. According to an embodiment, each of the plurality of first antenna elements may include a radiator in a form of a patch. The second antenna module 503 may include a plurality of second antenna elements. According to an embodiment, each of the plurality of second antenna elements may include a radiator in a form of a patch.

According to an embodiment, the first antenna module 501 may adjust a direction of a formed beam by adjusting a phase of a signal generated by antenna elements.

According to an embodiment, the first antenna module 501 may adjust a direction of a formed beam by changing phases of signals to be provided to antenna elements. Phase shift values for antenna elements may be predefined. At least one processor (e.g., the processor 120 of FIG. 1) may form a beam using the antenna elements of the first antenna module 501 through a combination of phase shift values corresponding to a beam identifier (ID). The at least one processor 120 may include a communication processor (CP) (e.g., the auxiliary processor 123 of FIG. 1). A beam ID corresponding to an individual beam may be identified according to a direction of a beam to be formed. For example, a beam ID of a beam having the smallest angle with a −Z axis among beams that the first antenna module 501 may generate may be ‘00’. A beam ID of a beam having the smallest angle with a +Z axis among the beams that the first antenna module 501 may generate may be ‘06’.

According to an embodiment, the second antenna module 503 may adjust a direction of a formed beam by changing phases of signals to be provided to antenna elements. The phase shift values for the antenna elements may be predefined. The at least one processor 120 may form a beam using the antenna elements of the second antenna module 503 through the combination of the phase shift values corresponding to the beam ID. A beam ID corresponding to the individual beam may be identified according to the direction of the beam to be formed. For example, a beam ID of a beam having the smallest angle with the −Z axis among beams that the second antenna module 503 may generate may be ‘06’. A beam ID of a beam having the smallest angle with the +Z axis among the beams that the second antenna module 503 may generate may be ‘00’.

According to an embodiment, each of the plurality of first antenna elements may transmit or receive a signal having a first polarization characteristic. For example, the at least one processor 120 may feed the signal having the first polarization characteristic to each of the plurality of first antenna elements of the first antenna module 501. Each of the plurality of second antenna elements may transmit or receive the signal having the first polarization characteristic. For example, the at least one processor 120 may feed the signal having the first polarization characteristic to each of the plurality of second antenna elements of the second antenna module 503.

According to an embodiment, each of the plurality of first antenna elements may transmit or receive a signal having a second polarization characteristic. For example, the at least one processor 120 may feed the signal having the second polarization characteristic to each of the plurality of first antenna elements of the first antenna module 503. Each of the plurality of second antenna elements may transmit or receive the signal having the second polarization characteristic. A direction of the first polarization and a direction of the second polarization may be perpendicular to each other. For example, the at least one processor 120 may feed the signal having the second polarization characteristic to each of the plurality of second antenna elements of the second antenna module 503.

According to an embodiment, the at least one processor 120 may identify that a power saving mode of the electronic device 101, in which the electronic device 101 uses power less than a reference value, is set. According to an embodiment, the power saving mode may be set based on a user input for performing communication at low power. According to another embodiment, the power saving mode may be set to perform communication at low power based on a remaining battery capacity less than the reference value. When the electronic device 101 is set to the single antenna mode and the power saving mode, the at least one processor 120 may identify a polarization in the electronic device 101 to lower power consumption. For example, when the electronic device 101 is set to the single antenna mode and the power saving mode, the at least one processor 120 may identify the first polarization (e.g., an H polarization) to lower power consumption. For example, when the electronic device 101 is set to the single antenna mode and the power saving mode, the at least one processor 120 may identify the second polarization (e.g., a V polarization) to lower power consumption.

In an embodiment, an antenna module may be mounted in a structure of the electronic device 101. In such an embodiment where an antenna module is disposed in the electronic device 101, a strength of a beam transmitted and received by the antenna module may vary according to a direction of the beam by another component of the electronic device 101. This is because a degree to which a conductive portion included in the other component reflects the beam having the first polarization characteristic and a degree to which the conductive portion reflects the beam having the second polarization characteristic may be different. For example, with respect to a specific beam direction, a strength of the beam having the first polarization characteristic transmitted and received by the first antenna element may be greater than a strength of the beam having the second polarization characteristic transmitted and received by the first element. With respect to another beam direction, the strength of the beam having the first polarization characteristic transmitted and received by the first antenna element may be smaller than the strength of the beam having the second polarization characteristic transmitted and received by the first element. Therefore, in the single antenna mode (e.g., single input single output (SISO)), performing communication by fixedly selecting one polarization may cause deterioration in a communication performance.

The at least one processor 120 according to embodiments may select a polarization for the electronic device 101 from among various polarizations to improve an antenna performance. The at least one processor 120 may include the communication processor (CP) (e.g., the auxiliary processor 123 of FIG. 1). The at least one processor 120 may perform beamforming through the selected polarization. The at least one processor 120 may perform both a beam search for the first polarization (e.g., a procedure for identifying a specific beam among beams of ‘00’, ‘01’, ‘02’ ‘03’, ‘04’, ‘05’, and ‘06’ of the first antenna module 501) and a beam search for the second polarization, to select the polarization for the electronic device 101. However, since the at least one processor 120 should use both a path for the first polarization and a path for the second polarization in the SISO, it may consume more power than a case of using one path.

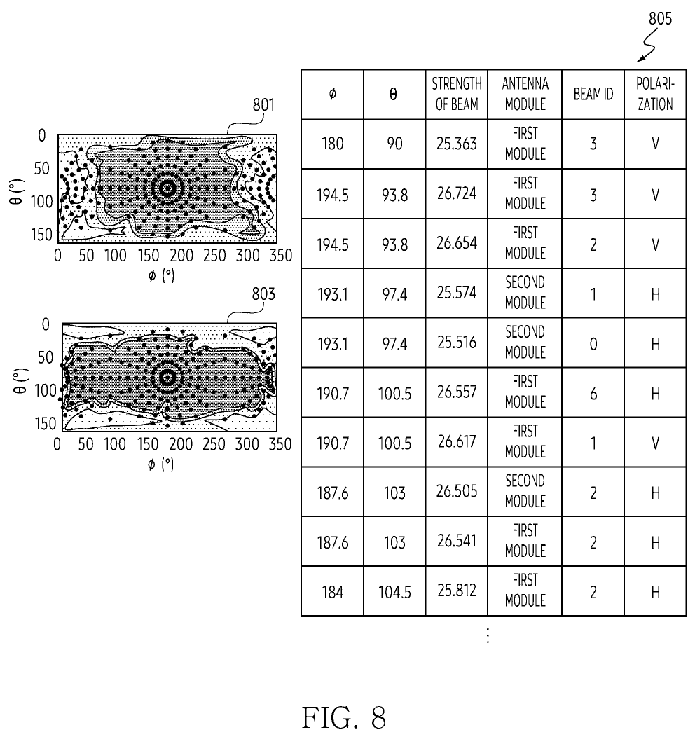

According to an embodiment, the at least one processor 120 may perform an operation for lowering power consumption and improving an antenna performance. According to an embodiment, the at least one processor 120 may identify whether network communication quality (e.g., RSRP) is less than a threshold to determine whether a weak electric field is present. The at least one processor 120 may set the electronic device 101 to the single antenna mode (e.g., the SISO) based on identifying the network communication quality less than the threshold. The at least one processor 120 may set the electronic device 101 to the power saving mode using the power less than the reference value. According to an embodiment, the power saving mode may be set based on the user input for performing communication at low power. According to another embodiment, the power saving mode may be set to perform communication at low power based on the remaining battery capacity less than the reference value. The at least one processor 120 may identify a signal strength in each of a plurality of directions. The at least one processor 120 may identify the direction information of the base station (or the direction information for the base station) based on a direction of a signal having the greatest signal strength. The at least one processor 120 may identify an antenna module among the first antenna module and the second antenna module based on the direction information of the base station. For example, the at least one processor 120 may identify the antenna module corresponding to the direction information of the base station from a mapping table (e.g., table 805 of FIG. 8 below). The at least one processor 120 may identify a beam ID based on the direction information of the base station. For example, the at least one processor 120 may identify the beam ID corresponding to the direction information of the base station from the mapping table (e.g., the table 805 of FIG. 8 below). The at least one processor 120 may identify (or set) a polarization mode as one of a first polarization mode or a second polarization mode based on the direction information of the base station. For example, the at least one processor 120 may identify the polarization mode as a polarization mode corresponding to the direction information of the base station from the mapping table (e.g., the table 805 of FIG. 8 below). The at least one processor 120 may transmit a signal based on the identified antenna module, a communication path corresponding to the identified polarization mode, and the identified beam ID.

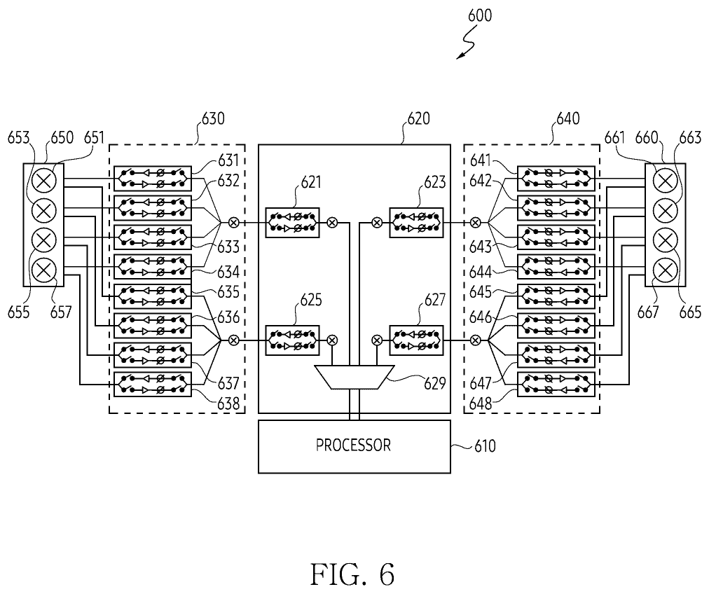

FIG. 6 illustrates an example of a configuration of an electronic device for receiving a signal through an antenna, according to embodiments. Although FIG. 6 illustrates an embodiment having a structure in which the electronic device includes a first antenna module and a second antenna module, an additional antenna module may be included in the electronic device. Applying the additional antenna module to a structure of the electronic device according to embodiments for beam activation may be to a simple design change, and any detailed description thereof will be omitted.

Referring to FIG. 6, an electronic device 101 according to an embodiment may include all or a portion of a processor 610 (e.g., the processor 120 of FIG. 1), communication circuitry 620, a first RFIC 630, a second RFIC 640, a first antenna module 650, or a second antenna module 660. The at least one processor 120 may include a communication processor (CP) (e.g., the auxiliary processor 123 of FIG. 1).

According to an embodiment, four antenna element portions (a first antenna element portion 651, a second antenna element portion 653, a third antenna element portion 655, and a fourth antenna element portion 657) included in the first antenna module 650 may be electrically connected to four ports provided for a first polarization and four ports provided for a second polarization, in the first RFIC 630. Each of the four antenna element portions (the first antenna element portion 651, the second antenna element portion 653, the third antenna element portion 655, and the fourth antenna element portion 657) may be electrically connected to, for example, one port provided for the first polarization and one port provided for the second polarization.

According to an embodiment, the first antenna element portion 651 included in the first antenna module 650 may be electrically connected to, for example, first transmission/reception circuitry 631 for transmission and reception of the first polarization and included in the first RFIC 630 and fifth transmission/reception circuitry 635 for transmission and reception of the second polarization and included in the first RFIC 630. The second antenna element portion 653 included in the first antenna module 650 may be electrically connected to, for example, second transmission/reception circuitry 632 for transmission and reception of the first polarization and included in the first RFIC 630 and sixth transmission/reception circuitry 636 for transmission and reception of the second polarization and included in the first RFIC 630. The third antenna element portion 655 included in the first antenna module 650 may be electrically connected to, for example, third transmission/reception circuitry 633 for transmission and reception of the first polarization and included in the first RFIC 630 and seventh transmission/reception circuitry 637 for transmission and reception of the second polarization and included in the first RFIC 630. The fourth antenna element portion 657 included in the first antenna module 650 may be electrically connected to, for example, fourth transmission/reception circuitry 634 for transmission and reception of the first polarization and included in the first RFIC 630 and eighth transmission/reception circuitry 638 for transmission and reception of the second polarization and included in the first RFIC 630.

According to an embodiment, the first to fourth transmission/reception circuitries (the first transmission/reception circuitry 631, the second transmission/reception circuitry 632, the third transmission/reception circuitry 633, and the fourth transmission/reception circuitry 634) included in the first RFIC 630 for transmission and reception of the first polarization may include switches forming a path so that a first mixer, which performs an uplink frequency conversion and a downlink frequency conversion with respect to the first polarization according to a beam to be used, may be electrically connected to at least one of the four antenna element portions (the first antenna element portion 651, the second antenna element portion 653, the third antenna element portion 655, and the fourth antenna element portion 657) included in the first antenna module 650.

According to an embodiment, the fifth to eighth transmission/reception circuitries (the fifth transmission/reception circuitry 635, the sixth transmission/reception circuitry 636, the seventh transmission/reception circuitry 637, and the eighth transmission/reception circuitry 638) included in the first RFIC 630 for transmission and reception of the second polarization may include switches forming a path so that a second mixer, which performs an uplink frequency conversion and a downlink frequency conversion with respect to the second polarization according to a beam to be used, may be electrically connected to at least one of the four antenna element portions (the first antenna element portion 651, the second antenna element portion 653, the third antenna element portion 655, and the fourth antenna element portion 657) included in the first antenna module 650.

According to an embodiment, four antenna element portions (a fifth antenna element portion 661, a sixth antenna element portion 663, a seventh antenna element portion 665, and an eighth antenna element portion 667) included in the second antenna module 660 may be electrically connected to four ports provided for the first polarization in the second RFIC 640. Each of the four antenna element portions (the fifth antenna element portion 661, the sixth antenna element portion 663, the seventh antenna element portion 665, and the eighth antenna element portion 667) may be electrically connected to, for example, one port provided for the first polarization and one port provided for the second polarization.

According to an embodiment, the fifth antenna element portion 661 included in the second antenna module 660 may be electrically connected to, for example, first transmission/reception circuitry 641 for transmission and reception of the first polarization and included in the second RFIC 640, and fifth transmission/reception circuitry 645 for transmission and reception of the second polarization and included in the second RFIC 640. The sixth antenna element portion 663 included in the second antenna module 660 may be electrically connected to, for example, second transmission/reception circuitry 642 for transmission and reception of the first polarization and included in the second RFIC 640, and sixth transmission/reception circuitry 646 for transmission and reception of the second polarization and included in the second RFIC 640. The seventh antenna element portion 665 included in the second antenna module 660 may be electrically connected to, for example, third transmission/reception circuitry 643 for transmission and reception of the first polarization and included in the second RFIC 640 and seventh transmission/reception circuitry 647 for transmission and reception of the second polarization and included in the second RFIC 640. The eighth antenna element portion 667 included in the second antenna module 660 may be electrically connected to, for example, fourth transmission/reception circuitry 644 for transmission and reception of the first polarization and included in the second RFIC 640 and eighth transmission/reception circuitry 648 for transmission and reception of the second polarization and included in the second RFIC 640.

According to an embodiment, the first to fourth transmission/reception circuitries (the first transmission/reception circuitry 641, the second transmission/reception circuitry 642, the third transmission/reception circuitry 643, and the fourth transmission/reception circuitry 644) included in the second RFIC 640 for transmission and reception of the first polarization may include switches forming a path so that a third mixer, which performs an uplink frequency conversion and a downlink frequency conversion with respect to the second polarization according to a beam to be used, may be electrically connected to at least one of the four antenna element portions (the fifth antenna element portion 661, the sixth antenna element portion 663, the seventh antenna element portion 665, and the eighth antenna element portion 667) included in the second antenna module 660.

According to an embodiment, the fifth to eighth transmission/reception circuitries (the fifth transmission/reception circuitry 645, the sixth transmission/reception circuitry 646, the seventh transmission/reception circuitry 647, and the eighth transmission/reception circuitry 648) included in the second RFIC 640 for transmission and reception of the second polarization may include switches forming a path so that a fourth mixer, which performs an uplink frequency conversion and a downlink frequency conversion with respect to the second polarization according to a beam to be used, may be electrically connected to at least one of the four antenna element portions (the fifth antenna element portion 661, the sixth antenna element portion 663, the seventh antenna element portion 665, and the eighth antenna element portion 667) included in the second antenna module 660.

According to an embodiment, the communication circuitry 620 may include four path connection circuitries (e.g., a first connection path 621, a second connection path 623, a third connection path 625, and a fourth connection path 627), fifth to eighth mixers, and a multiplexer and demultiplexer 629. The four path connection circuitries 621, 623, 625, and 627 may electrically connect, for example, the fifth to eighth mixers to the first RFIC 630 or the second RFIC 640.

According to an embodiment, the first path connection circuitry 621 may electrically connect the fifth mixer to a first mixer included in the first RFIC 630, the second path connection circuitry 623 may electrically connect the sixth mixer to a third mixer included in the second RFIC 640, the third path connection circuitry 625 may electrically connect the seventh mixer to a second mixer included in the first RFIC 630, and the fourth path connection circuitry 627 may electrically connect the eighth mixer to a fourth mixer included in the second RFIC 640.

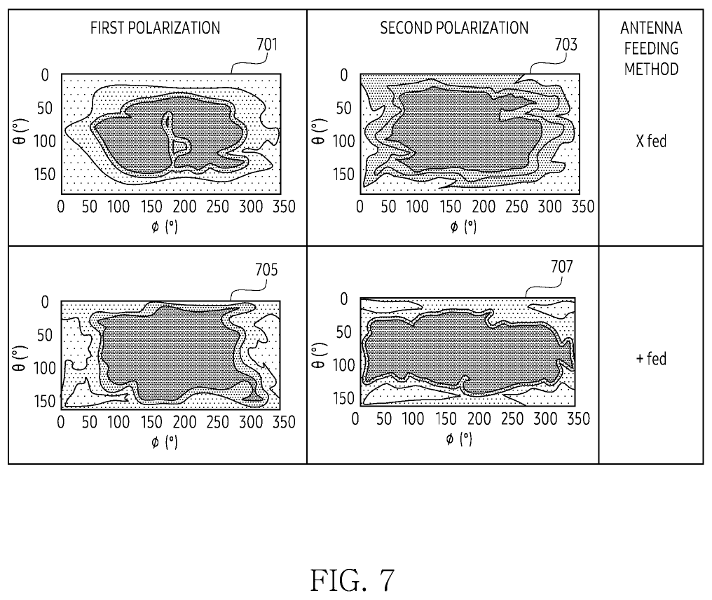

FIG. 7 illustrates an example of a strength of a beam transmitted based on a polarization mode according to a mounting method of antenna elements, according to embodiments.

Referring to FIG. 7, a graph 701 illustrates a strength of a signal having a first polarization characteristic transmitted by an antenna according to a direction of the signal, when an antenna module is fed in an ‘x’ shape (i.e., cross-pole). The direction may be represented in a polar coordinate with respect to a center of an electronic device. A graph 703 illustrates the strength of the signal having the first polarization characteristic transmitted by the antenna according to the direction of the signal, when the antenna module is fed in the ‘x’ shape. The direction may be represented in the polar coordinate with respect to the center of the electronic device. The first polarization characteristic may be an H polarization characteristic. A graph 705 illustrates a strength of a signal having a second polarization characteristic transmitted by an antenna according to a direction of the signal, when the antenna module is fed in a ‘+’ shape. A graph 707 illustrates the strength of the signal having the second polarization characteristic transmitted by the antenna according to the direction of the signal, when the antenna module is fed in the ‘+’ shape. The second polarization characteristic may be a V polarization characteristic. According to an embodiment, the antenna module may include a conductive member configuring an antenna element. According to another embodiment, the antenna module may include the first conductive member and the second conductive member configuring the antenna element. The first conductive member and the second conductive member may be disposed perpendicular to each other. When the antenna module is fed in the X shape, the first conductive member and the second conductive member may be disposed in a direction of approximately −45 degrees and approximately +45 degrees, respectively, with respect to a long direction (e.g., a Z-axis direction of FIG. 5) from a side surface of the electronic device. When the antenna module is fed in the ‘+’ shape, the first conductive member and the second conductive member may be disposed in a direction of 0-degree and 90-degree, respectively, with respect to the long direction (e.g., the Z-axis direction of FIG. 5) from the side surface of the electronic device.

In an embodiment where the antenna module is disposed in an electronic device 101, a strength of a beam transmitted and received by the antenna module may vary according to a direction by another electronic component of the electronic device 101. This is because a degree to which a conductive portion included in the other electronic component reflects a beam having the first polarization characteristic and a degree to which the conductive portion reflects a beam having the second polarization characteristic may be different. In the graphs 701 and 703, even in the same direction (the same polar coordinate), an identified strength may differ according to whether the antenna transmits a beam of the first polarization or the antenna transmits a beam of the second polarization. In the graphs 705 and 707, even in the same direction (the same polar coordinate), the identified strength may differ according to whether the antenna transmits the beam of the first polarization or the antenna transmits the beam of the second polarization. Therefore, at least one processor (e.g., the processor 120 of FIG. 1) may identify a polarization that provides a greater beam strength (e.g., Equivalent Isotropic Radiated Power (EIRP)) in a corresponding direction based on direction information of a base station. The at least one processor 120 may improve a radiation performance of the antenna module by selecting a more suitable polarization. The at least one processor 120 may include a communication processor (CP) (e.g., the auxiliary processor 123 of FIG. 1).

According to an embodiment, the at least one processor 120 may identify, from a mapping table, an antenna module, a beam ID, and a polarization mode that correspond to the direction information of the base station. The at least one processor 120 may transmit a signal based on the identified antenna module, a communication path corresponding to the identified polarization mode, and the beam ID to lower power consumption.

FIG. 8 illustrates an example of identification of an antenna module, a beam ID, and a polarization mode according to direction information of a base station, according to embodiments.

Referring to FIG. 8, a graph 801 illustrates a strength of a signal having a first polarization characteristic transmitted by an antenna according to a direction of the beam with respect to the electronic device 101. An x-axis may be a φ value. A unit of the x-axis may be a degree. A y-axis may be a θ value. A unit of the y-axis may be a degree. For example, the first polarization characteristic may be an H polarization characteristic. A graph 803 illustrates a strength of a signal having a second polarization characteristic transmitted by the antenna according to the direction of the beam with respect to the electronic device 101. An x-axis may be a φ value. A unit of the x-axis may be a degree. A y-axis may be a θ value. A unit of the y-axis may be a degree. For example, the second polarization characteristic may be a V polarization characteristic. Table 805 illustrates a mapping table for identifying an antenna module, a beam ID, and a polarization mode corresponding to the direction information of the base station.

In an embodiment where the antenna module is disposed in the electronic device 101, a strength of a beam transmitted and received by the antenna module may vary according to a direction by another electronic component of the electronic device 101. This is because a degree to which a conductive portion included in the other electronic component reflects a beam having the first polarization characteristic and a degree to which the conductive portion reflects a beam having the second polarization characteristic may be different. In the graphs 801 and 803, even if a beam direction is in the same direction (the same polar coordinate), an identified strength may differ according to whether the antenna transmits a beam of a first polarization or the antenna transmits a beam of a second polarization. Therefore, at least one processor (e.g., the processor 120 of FIG. 1) may identify the direction information of the base station and transmit or receive a beam based on a strength of the beam according to the polarization mode in the direction information of the base station. The at least one processor 120 may include a communication processor (CP) (e.g., the auxiliary processor 123 of FIG. 1).

According to an embodiment, an φ value and an θ value in the table 805 may be determined based on the direction information of the base station. The table 805 may be a mapping table. The at least one processor 120 may identify the antenna module, the beam ID, and the polarization mode corresponding to the direction information of the base station from the table 805. The φ value and the θ value may be identified based on a coordinate using a center of the electronic device 101 as an origin. The at least one processor 120 may identify an antenna module, a beam ID, and a polarization mode having a higher strength value with respect to the same φ value and the θ value. For example, in case that a φ value is approximately 190.7 degrees and a θ value is approximately 100.5 degrees, a strength of a beam transmitted and received may vary to approximately 26.557 decibel milliwatts (dBm) or approximately 26.617 dBm according to a beam ID and a polarization mode. According to an embodiment, the at least one processor 120 may identify a V polarization corresponding to a strength of a beam of approximately 26.617 dBm. The at least one processor 120 may activate a communication path for the V polarization. At this time, the at least one processor 120 may reduce power consumption by deactivating a communication path for an H polarization different from the V polarization. The at least one processor 120 may perform a beam search based on the V polarization.

In an embodiment, instead of a separate beam search, the at least one processor 120 may identify an optimal beam based on the table 805. According to an embodiment, the at least one processor 120 may identify a beam ID of ‘0’ and a first antenna module that correspond to the strength of the beam of approximately 26.617 dBm. According to an embodiment, the at least one processor 120 may form a beam corresponding to the beam ID of ‘0’ through phase adjustment for each of antenna elements of the first antenna module.

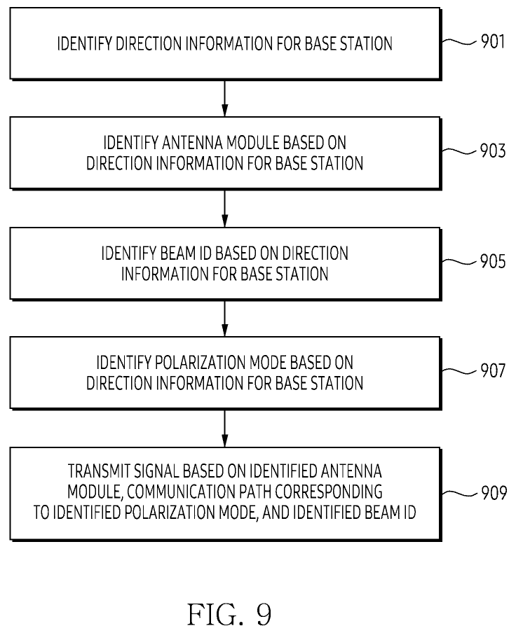

FIG. 9 a flow chart of an operation of an electronic device for receiving a signal based on direction information of a base station and a polarization mode, according to embodiments.

Referring to FIG. 9, in an embodiment of an operation of an electronic device, in an operation 901, at least one processor (e.g., the processor 120 of FIG. 1) may identify (e.g., obtain or calculate) direction information of a base station. The at least one processor 120 may include a communication processor (CP) (e.g., the auxiliary processor 123 of FIG. 1). The at least one processor 120 may indicate the direction information of the base station as an φ value and an θ value. The φ value and the θ value may be identified (or determined) based on a coordinate using a center of an electronic device 101 as an origin.

In an operation 903, the at least one processor 120 may identify (determine or select) an antenna module based on the direction information of the base station. According to the direction information of the base station, an antenna module having the greatest strength of a beam being transmitted or received among a plurality of antenna modules (e.g., a first antenna module and a second antenna module) may be identified. A mapping table (e.g., the table 805 of FIG. 8) may be referenced or used to identify the antenna module. The electronic device 101 may include the first antenna module (e.g., the first antenna module 501 of FIG. 5) in a first side surface of the electronic device 101. The electronic device 101 may include the second antenna module (e.g., the second antenna module 503 of FIG. 5) in the second side surface opposite to the first side surface of the electronic device 101.

In an operation 905, the at least one processor 120 may identify (determine or select) a beam ID based on the direction information of the base station. According to the direction information of the base station, a beam having the largest beam strength among a plurality of beams may be identified. The mapping table (e.g., the table 805 of FIG. 8) may be referenced or used to identify the beam ID. The at least one processor 120 may adjust a direction of a formed beam by adjusting a phase of a signal generated by antenna elements. A beam ID corresponding to an individual beam may be identified based on a direction in which a beam is transmitted and received.

In an operation 907, the at least one processor 120 may identify (determine or select) a polarization mode based on the direction information of the base station. Each of the plurality of first antenna elements may transmit and receive a signal having a first polarization characteristic. Each of the plurality of first antenna elements may transmit and receive a signal having a second polarization characteristic. Each of the plurality of second antenna elements may transmit and receive the signal having the first polarization characteristic. Each of the plurality of second antenna elements may transmit and receive the signal having the second polarization characteristic. A direction of the first polarization and a direction of the second polarization may be perpendicular to each other. According to an embodiment, where the antenna module is disposed in the electronic device 101, a strength of a beam transmitted and received by the antenna module may vary according to a direction by another electronic component of the electronic device 101. This is because a degree to which a conductive portion included in the other electronic component reflects a beam having the first polarization characteristic and a degree to which the conductive portion reflects a beam having the second polarization characteristic may be different. For example, with respect to a specific direction, a strength of the beam having the first polarization characteristic transmitted and received by the first antenna element may be greater than a strength of the beam having the second polarization characteristic transmitted and received by the second element. In another direction, the strength of the beam having the first polarization characteristic transmitted and received by the first antenna element may be smaller than the strength of the beam having the second polarization characteristic transmitted and received by the second element. Therefore, when operating in a single antenna mode (e.g., single input single output (SISO)), the at least one processor 120 may identify a polarization characteristic corresponding to the direction information of the base station by referring to the mapping table to reduce power consumption and improve an antenna performance.

In an operation 909, the at least one processor 120 may transmit a signal based on the identified antenna module, a communication path corresponding to the identified polarization mode, and the identified beam ID. The at least one processor 120 may deactivate the communication path based on the identified antenna module and the identified polarization mode. For example, the at least one processor 120 may identify an H polarization mode of the first antenna module based on the direction information of the base station. The at least one processor 120 may deactivate a communication path corresponding to the second antenna module and a communication path corresponding to a V polarization mode of the first antenna module. The at least one processor 120 may transmit and receive a signal corresponding to the identified beam ID by adjusting a phase of a signal generated by each of antenna elements of an activated communication path.

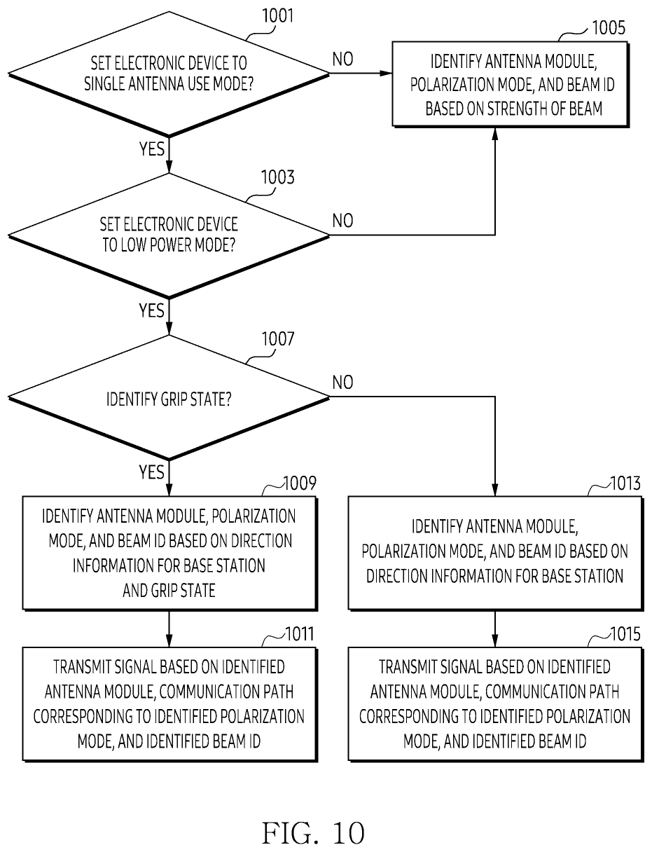

FIG. 10 is a flow chart of an operation of an electronic device for selecting an antenna to be used based on a mode of the electronic device, according to embodiments.

Referring to FIG. 10, in an embodiment of an operation of an electronic device for selecting an antenna to be used based on a mode of the electronic device, in an operation 1001, at least one processor (e.g., the processor 120 of FIG. 1) may identify whether the electronic device is set to a single antenna mode. The at least one processor 120 may include a communication processor (CP) (e.g., the auxiliary processor 123 of FIG. 1). In case of being set to the single antenna mode, the at least one processor 120 may perform an operation 1003. In case of not being set to the single antenna mode, the at least one processor 120 may perform an operation 1005. The single antenna mode may be referred to as a single input single output (SISO) mode. According to an embodiment, the at least one processor 120 may identify whether network communication quality is less than a threshold. The at least one processor 120 may set the electronic device to the multi-antenna mode based on identifying (e.g., when it is identified) that the network communication quality is not less than the threshold. The at least one processor 120 may use a first feeding path for a first polarization and a second feeding path for a second polarization in the multi-antenna mode. The at least one processor 120 may set the single antenna mode based on identifying (e.g., when it is identified) that the network communication quality is less than the threshold. The at least one processor 120 may use the first feeding path for the first polarization or the second feeding path for the second polarization in the single antenna mode.

In the operation 1003, the at least one processor 120 may identify whether the electronic device is set to a low power mode. In case of being set to the low power mode, the at least one processor 120 may perform an operation 1007. In case of not being set to the low power mode, the at least one processor 120 may perform the operation 1005. According to an embodiment, the at least one processor 120 may identify that the electronic device is set to a power saving mode in which power less than a reference value is used. Power consumption when transmitting signals having various polarization characteristics at the same time may be greater than power consumption when transmitting a signal having a single polarization characteristic. Power consumption when receiving the signals having the various polarization characteristics at the same time may be greater than power consumption when receiving the signal having the single polarization characteristic. According to an embodiment, the at least one processor 120 may identify an antenna module, a beam ID, and a polarization mode based on a mapping table to reduce power consumption and improve an antenna performance.

In the operation 1005, the at least one processor 120 may identify an antenna module, a polarization mode, and a beam ID based on a strength of a beam. The at least one processor 120 may identify the strength of the beam by changing the antenna module, the polarization mode, and the beam ID. The at least one processor 120 may transmit or receive a signal based on the antenna module, the polarization mode, and the beam ID having the large beam strength. However, power consumption when identifying the antenna module, the polarization mode, and the beam ID based on the strength of the beam may be higher than power consumption when identifying the antenna module, the polarization mode, and the beam ID based on the mapping table as the strength of the beam is identified, by changing antenna settings multiple times.

In the operation 1007, the at least one processor 120 may identify a grip state. In case that the grip state is identified, the at least one processor 120 may perform an operation 1009. In case that the grip state is not identified, the at least one processor 120 may perform an operation 1013. The at least one processor 120 may identify that the electronic device 101 is gripped through a grip sensor. The at least one processor 120 may identify a degree of blockage for the antenna module based on identifying (e.g., when it is identified) that the electronic device is gripped. For example, the at least one processor 120 may identify the degree of blockage for the antenna module through the grip sensor based on identifying (e.g., when it is identified) that the electronic device is gripped. For example, the at least one processor 120 may identify the degree of blockage for the antenna module through the antenna module (e.g., a mmWave module) based on identifying (e.g., when it is identified) that the electronic device is gripped.

In the operation 1009, the at least one processor 120 may identify the antenna module, the polarization mode, and the beam ID based on the direction information of the base station and the grip state. As a user grips the electronic device 101, the antenna module may be covered (or blocked) by a hand of the user. A performance of the antenna module blocked by the hand of the user may be lowered. Therefore, the at least one processor 120 may identify the antenna module, the polarization mode, and the beam ID in consideration of influence by the hand of the user. The at least one processor 120 may identify the antenna module corresponding to the identified degree of blockage and the direction information of the base station based on a mapping table corresponding to the grip state. The at least one processor 120 may identify the polarization mode corresponding to the identified degree of blockage and the direction information of the base station based on the mapping table corresponding to the grip state. The at least one processor 120 may identify the direction information of the base station and the beam ID that correspond to the identified degree of blockage (occlusion) based on the mapping table corresponding to the grip state. The at least one processor 120 may identify an antenna module, a polarization mode, and a beam ID in which the influence by the hand of the user is minimized based on the mapping table corresponding to the grip state.

In an operation 1011, the at least one processor 120 may transmit and receive the signal based on the identified antenna module, a communication path corresponding to the identified polarization mode, and the identified beam ID. The at least one processor 120 may transmit or receive the signal based on the identified antenna module, the communication path corresponding to the identified polarization mode, and the identified beam ID to minimize power consumption and improve an antenna performance.

In the operation 1013, the at least one processor 120 may identify the antenna module, the polarization mode, and the beam ID based on the direction information of the base station. According to the direction information of the base station, an antenna module having the largest strength of a beam transmitted or received from among a plurality of antenna modules (e.g., a first antenna module and a second antenna module) may be identified. A mapping table (e.g., the table 805 of FIG. 8) may be referenced to identify the antenna module. According to the direction information of the base station, a beam having the largest beam strength among a plurality of beams may be identified. The mapping table (e.g., the table 805 of FIG. 8) may be referenced to identify the beam ID. In the single antenna mode (e.g., single input single output (SISO)), the at least one processor 120 may identify a polarization characteristic corresponding to the direction information of the base station by referring to the mapping table to reduce power consumption and improve an antenna performance.

In an operation 1015, the at least one processor 120 may transmit the signal based on the identified antenna module, the communication path corresponding to the identified polarization mode, and the identified beam ID. The at least one processor 120 may deactivate the communication path by corresponding the identified antenna module and the identified polarization mode. For example, the at least one processor 120 may identify an H polarization mode of the first antenna module based on the direction information of the base station. The at least one processor 120 may deactivate a communication path corresponding to the second antenna module and a communication path corresponding to a V polarization mode of the first antenna module. The at least one processor 120 may transmit and receive the signal corresponding to the identified beam ID by adjusting a phase of a signal generated by each of antenna elements of an activated communication path.

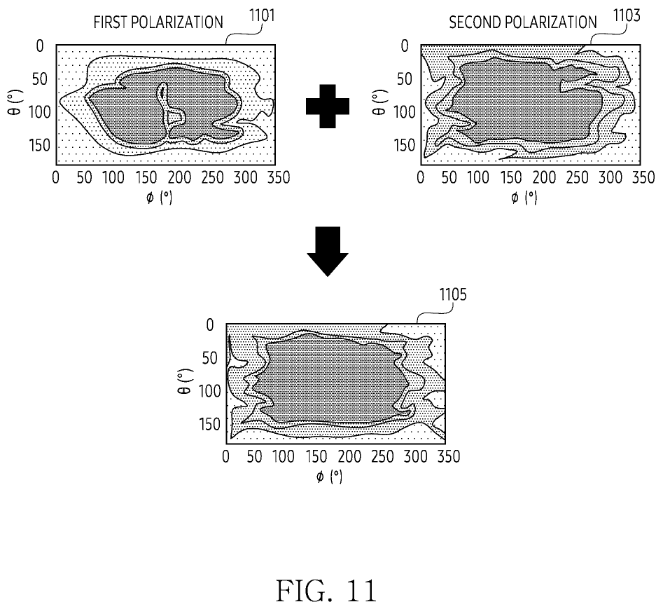

FIG. 11 illustrates an effect according to a change in a polarization mode of an antenna.

Referring to FIG. 11, a graph 1101 illustrates a strength of a signal having a first polarization characteristic transmitted by an antenna according to a direction of the signal. An x-axis may be a φ value. A unit of the x-axis may be a degree. A y-axis may be a θ value. A unit of the y-axis may be a degree. A graph 1103 illustrates a strength of a signal having a second polarization characteristic transmitted by the antenna according to a direction of the signal. An x-axis may be a φ value. A unit of the x-axis may be a degree. A y-axis may be a θ value. A unit of the y-axis may be a degree. A graph 1105 illustrates a strength of a signal transmitted by the antenna according to a direction of the signal, according to an embodiment. An x-axis may be a φ value. A unit of the x-axis may be a degree. A y-axis may be a θ value. A unit of the y-axis may be a degree. The direction may be indicated by a polar coordinate with respect to a center of an electronic device.

According to an embodiment, where an antenna module is disposed in an electronic device 101, a strength of a beam transmitted and received by the antenna module may vary according to a direction by another electronic component of the electronic device 101 because a degree to which a conductive portion included in the other electronic component reflects a beam having the first polarization characteristic and a degree to which the conductive portion reflects a beam having the second polarization characteristic may be different.

According to an embodiment, in the graphs 1101 and 1103, even in the same direction (the same polar coordinate), an identified strength may differ according to whether the antenna transmits a beam of a first polarization or the antenna transmits a beam of a second polarization. Therefore, in an embodiment, at least one processor (e.g., the processor 120 of FIG. 1) may identify direction information of a base station and improve an antenna performance when transmitting or receiving a beam with a polarization having a greater beam strength in the direction information of the base station. The at least one processor 120 may include a communication processor (CP) (e.g., the auxiliary processor 123 of FIG. 1).

According to an embodiment, the at least one processor 120 may identify, from a mapping table, an antenna module, a beam ID, and a polarization mode that correspond to the direction information of the base station. The at least one processor 120 may transmit a signal based on the identified antenna module, a communication path corresponding to the identified polarization mode, and the beam ID to lower power consumption.

According to an embodiment, the direction information of the base station may indicate a first point on the graphs (the graph 1101, the graph 1103, and the graph 1105). The at least one processor 120 may transmit and receive a beam of a polarization mode corresponding to a graph having a greater strength by comparing a strength of a beam corresponding to the first point of the graph 1101 with a strength of a beam corresponding to the first point of the graph 1103. For example, the direction information of the base station may have a φ value of 190 degrees and a 0 value of approximately 100 degrees. The first point may be a coordinate on a graph in which the φ value is approximately 190 degrees and the θ value is approximately 100 degrees. The strength of the beam at the first point of the graph 1101 may be less than the strength of the beam at the first point of the graph 1103. The strength of the beam at the first point of the graph 1105 may be the strength of the beam at the first point of the graph 1103. This is because, according to an embodiment, a polarization mode change is possible at the first point, and thus the beam of the second polarization will be transmitted and received. Therefore, in an embodiment, the polarization mode is changed according to the direction information of the base station, such that an antenna performance may be improved.

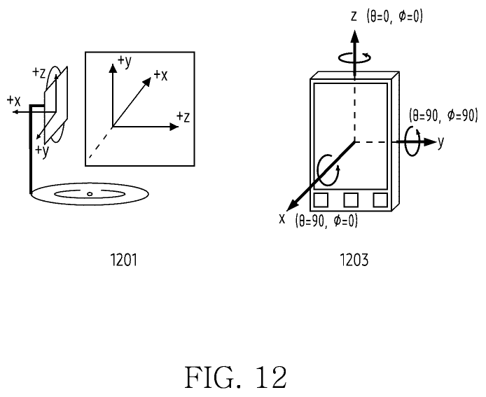

FIG. 12 illustrates an example of a coordinate that is a reference of direction information of a base station.

Referring to FIG. 12, at least one processor (e.g., the processor 120 of FIG. 1) may identify a position of a beam based on a chamber antenna through a coordinate setting method 1201. The at least one processor 120 may include a communication processor (CP) (e.g., the auxiliary processor 123 of FIG. 1). The chamber antenna may be a measurement sensor for determining a strength of the beam according to a direction with respect to the chamber antenna. The at least one processor may determine the position of the beam based on an electronic device 101 through a coordinate setting method 1203. The electronic device (e.g., the electronic device 101 of FIG. 1) may identify an antenna module, a beam ID, and a polarization mode having a high antenna performance according to the direction information of the base station. The at least one processor 120 may identify an antenna performance through the chamber antenna according to the direction information of the base station. The antenna performance may be identified based on a strength of a signal received according to the direction information of the base station. The coordinate setting method 1203 may be referred to as a coordinate setting method of 3rd generation partnership project (3GPP) Orientation 6.

The at least one processor 120 may identify the strength of the signal received according to the direction information of the base station through the chamber antenna. The at least one processor 120 may convert the direction information of the base station with respect to the chamber antenna into the direction information of the base station with respect to the electronic device 101. The at least one processor 120 may identify an antenna module, a beam ID, and a polarization mode corresponding to the direction information of the base station with respect to the electronic device 101.

In embodiments, an electronic device 101 is provided. The electronic device may include at least one processor 120 or 610, a first antenna module 401, 501, or 650 including a plurality of first antenna elements 403, 405, 407 or 409, a second antenna module 401, 503, or 660 including a plurality of second antenna elements 403, 405, 407, or 409. Each of the plurality of first antenna elements 403, 405, 407 or 409 may be configured to transmit a signal of a first polarization or a second polarization different from the first polarization. Each of the plurality of second antenna elements 403, 405, 407, or 409 may be configured to transmit a signal of the first polarization or the second polarization. The at least one processor 120 or 610 may be configured to identify direction information of a base station. The at least one processor 120 or 610 may be configured to identify, based on the direction information of the base station, an antenna module among the first antenna module 401, 501, or 650 and the second antenna module 401, 503, or 660. The at least one processor 120 or 610 may be configured to identify, based on the direction information of the base station, a beam ID. The at least one processor 120 or 610 may be configured to identify, based on the direction information of the base station, a polarization mode as one of a first polarization mode or a second polarization mode. The at least one processor 120 or 610 may be configured to transmit a signal based on the identified antenna module, a communication path corresponding to the identified polarization mode, and the beam ID.

According to an embodiment, to identify the direction information of the base station, the at least one processor 120 or 610 may be configured to identify signal strengths in a plurality of directions. The at least one processor 120 or 610 may be configured to identify, based on a direction of a signal having the greatest signal strength, the direction information of the base station.

According to an embodiment, the electronic device 101 may further include a grip sensor. The at least one processor 120 or 610 may be further configured to identify that the electronic device is gripped through the grip sensor. The at least one processor 120 or 610 may be further configured to identify a degree of blockage for an antenna module based on identifying (e.g., when it is identified) that the electronic device is gripped. The at least one processor 120 or 610 may be further configured to identify the degree of blockage for the antenna module. The at least one processor 120 or 610 may be further configured to identify the antenna module corresponding to the direction information of the base station and the identified degree of blockage. The at least one processor 120 or 610 may be further configured to identify the polarization mode corresponding to the direction information of the base station and the identified degree of blockage. The at least one processor 120 or 610 may be further configured to transmit a signal based on the identified antenna module, the communication path corresponding to the identified polarization mode, and the beam ID.

According to an embodiment, the at least one processor 120 or 610 may be further configured to identify that the electronic device is set to a single antenna mode. The at least one processor 120 or 610 may be further configured to identify that the electronic device is set to a power-saving mode in which power less than a reference value is used. In the at least one processor 120 or 610, the direction information of the base station may be identified based on identifying (or when it is identified) that the electronic device is set to the single antenna mode and the power-saving mode.

According to an embodiment, to identify the antenna module, the at least one processor 120 or 610 may be configured to identify the antenna module corresponding to the direction information of the base station from a mapping table. To identify the beam ID, the at least one processor 120 or 610 may be configured to identify the beam ID corresponding to the direction information of the base station from the mapping table. To identify the polarization mode, the at least one processor 120 or 610 may be configured to identify the polarization mode corresponding to the direction information of the base station from the mapping table.

According to an embodiment, the at least one processor 120 or 610 may be configured to further identify whether network communication quality is lower than a threshold. The single antenna mode may be set based on identifying (or when it is identified) that the network communication quality is lower than the threshold.

According to an embodiment, each first antenna element among the plurality of first antenna elements 403, 405, 407, and 409 may include both a first conductive member and a second conductive member. Each second antenna element among the plurality of second antenna elements 403, 405, 407, and 409 may include both a third conductive member and a fourth conductive member. The first conductive member and the third conductive member may receive a beam having a first polarization characteristic based on a first polarization mode. The second conductive member and the fourth conductive member may receive a beam having a second polarization characteristic based on a second polarization mode.

According to an embodiment, each first antenna element among the plurality of first antenna elements 403, 405, 407, and 409 may be a patch antenna. Each second antenna element among the plurality of second antenna elements 403, 405, 407, and 409 may be a patch antenna.

According to embodiments, an electronic device 101 is provided. The electronic device may include at least one processor 120 or 610, a first antenna module 401, 501, or 650 including a plurality of first antenna elements 403, 405, 407 and 409, a second antenna module 401, 503, or 660 including a plurality of second antenna elements 403, 405, 407, and 409. Each of the plurality of first antenna elements 403, 405, 407 and 409 may be configured to receive a signal of a first polarization or a second polarization different from the first polarization. Each of the plurality of second antenna elements 403, 405, 407, and 409 may be configured to receive a signal of the first polarization or the second polarization. The at least one processor 120 or 610 may be configured to identify direction information of a base station. The at least one processor 120 or 610 may be configured to identify, based on the direction information of the base station, an antenna module among the first antenna module 401, 501, or 650 and the second antenna module 401, 503, or 660. The at least one processor 120 or 610 may be configured to identify, based on the direction information of the base station, a beam ID. The at least one processor 120 or 610 may be configured to identify, based on the direction information of the base station, a polarization mode as one of a first polarization mode or a second polarization mode. The at least one processor 120 or 610 may be configured to receive a signal based on the identified antenna module, a communication path corresponding to the identified polarization mode, and the beam ID.

According to an embodiment, to identify the direction information of the base station, the at least one processor 120 or 610 may be configured to identify signal strengths in a plurality of directions. The at least one processor 120 or 610 may be configured to identify, based on a direction of a signal having the greatest signal strength, the direction information of the base station.

According to an embodiment, the electronic device 101 may further include a grip sensor. The at least one processor 120 or 610 may be further configured to identify that the electronic device is gripped through the grip sensor. The at least one processor 120 or 610 may be further configured to identify a degree of blockage for an antenna module based on identifying (or when it is identified) that the electronic device is gripped. The at least one processor 120 or 610 may be further configured to identify the degree of blockage for the antenna module. The at least one processor 120 or 610 may be further configured to identify the antenna module corresponding to the direction information of the base station and the identified degree of blockage. The at least one processor 120 or 610 may be further configured to identify the polarization mode corresponding to the direction information of the base station and the identified degree of blockage. The at least one processor 120 or 610 may be further configured to receive a signal based on the identified antenna module, the communication path corresponding to the identified polarization mode, and the beam ID.

According to an embodiment, the at least one processor 120 or 610 may be further configured to identify that the electronic device is set to a single antenna mode. The at least one processor 120 or 610 may be further configured to identify that the electronic device is set to a power-saving mode in which power less than a reference value is used. The direction information of the base station may be identified based on identifying (or when it is identified) that the electronic device is set to the single antenna mode and the power-saving mode.

According to an embodiment, to identify the antenna module, the at least one processor 120 or 610 may be configured to identify the antenna module corresponding to the direction information of the base station from a mapping table. To identify the beam ID, the at least one processor 120 or 610 may be configured to identify the beam ID corresponding to the direction information of the base station from the mapping table. To identify the polarization mode, the at least one processor 120 or 610 may be configured to identify the polarization mode corresponding to the direction information of the base station from the mapping table.

According to an embodiment, the at least one processor 120 or 610 may be configured to further identify whether network communication quality is lower than a threshold. The single antenna mode may be set based on identifying (or when it is identified) that the network communication quality is lower than the threshold.

According to an embodiment, each first antenna element among the plurality of first antenna elements 403, 405, 407, and 409 may include both a first conductive member and a second conductive member. Each second antenna element among the plurality of second antenna elements 403, 405, 407, and 409 may include both a third conductive member and a fourth conductive member. The first conductive member and the third conductive member may receive a beam having a first polarization characteristic based on a first polarization mode. The second conductive member and the fourth conductive member may receive a beam having a second polarization characteristic based on a second polarization mode.

According to an embodiment, each first antenna element among the plurality of first antenna elements 403, 405, 407, and 409 may be a patch antenna. Each second antenna element among the plurality of second antenna elements 403, 405, 407, and 409 may be a patch antenna. According to embodiments, a method performed by an electronic device 101 is provided.

The method may include identifying direction information of a base station. The method may include identifying, based on the direction information of the base station, an antenna module among a first antenna module 401, 501, or 650 and a second antenna module 401, 503, or 660. The method may include identifying, based on the direction information of the base station, a beam ID. The method may include identifying, based on the direction information of the base station, a polarization mode as one of a first polarization mode or a second polarization mode. The method may include transmitting a signal based on the identified antenna module, a communication path corresponding to the identified polarization mode, and the beam ID.

According to an embodiment, the identifying the direction information of the base station may include identifying signal strengths in a plurality of directions. The identifying the direction information of the base station may include identifying, based on a direction of a signal having the greatest signal strength, the direction information of the base station.

According to an embodiment, the method may include identifying that the electronic device is gripped through a grip sensor. The method may further include identifying a degree of blockage for an antenna module based on identifying (or when it is identified) that the electronic device is gripped. The method may further include identifying the degree of blockage for the antenna module. The method may further include identifying the antenna module corresponding to the direction information of the base station and the identified degree of blockage. The method may further include identifying the polarization mode corresponding to the direction information of the base station and the identified degree of blockage. The method may further include transmitting a signal based on the identified antenna module, the communication path corresponding to the identified polarization mode, and the beam ID.

According to an embodiment, the method may further include identifying that the electronic device is set to a single antenna mode. The method may further include identifying that the electronic device is set to a power-saving mode in which power less than a reference value is used. The direction information of the base station may be identified based on identifying (or when it is identified) that the electronic device is set to the single antenna mode and the power-saving mode.

In embodiments, a method performed by an electronic device 101 is provided. The method may include identifying direction information of a base station, and identifying, based on the direction information of the base station, an antenna module among a first antenna module 401, 501, or 650 and a second antenna module 401, 503, or 660. The method may include identifying, based on the direction information of the base station, a beam ID. The method may include identifying, based on the direction information of the base station, a polarization mode as one of a first polarization mode or a second polarization mode. The method may include transmitting a signal based on the identified antenna module, a communication path corresponding to the identified polarization mode, and the beam ID.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (A SIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor;
a first antenna module including a plurality of first antenna elements; and
a second antenna module including a plurality of second antenna elements,
wherein each of the plurality of first antenna elements is configured to transmit a signal of a first polarization or a second polarization different from the first polarization,
wherein each of the plurality of second antenna elements is configured to transmit a signal of the first polarization or the second polarization,
wherein the at least one processor is configured to:
identify, based on direction information of a base station, an antenna module among the first antenna module and the second antenna module;
identify, based on the direction information of the base station, a beam identifier (ID);
identify, based on the direction information of the base station, a polarization mode as one of a first polarization mode or a second polarization mode; and
transmit a signal based on the identified antenna module, a communication path corresponding to the identified polarization mode, and the beam ID.

2. The electronic device of claim 1,
wherein the at least one processor is configured to identify the direction information of the base station by:
identifying signal strengths in a plurality of directions, and
identifying, based on a direction of a signal having a greatest signal strength, the direction information of the base station.

3. The electronic device of claim 1, further comprising:
a grip sensor,
wherein the at least one processor is further configured to:
identify that the electronic device is gripped through the grip sensor,
identify a degree of blockage for an antenna module based on identifying that the electronic device is gripped,
identify the antenna module corresponding to the direction information of the base station and the identified degree of blockage,
identify the polarization mode corresponding to the direction information of the base station and the identified degree of blockage, and
transmit a signal based on the identified antenna module, the communication path corresponding to the identified polarization mode, and the beam ID.

4. The electronic device of claim 1,
wherein the at least one processor is further configured to:
identify that the electronic device is set to a single antenna mode, and
identify that the electronic device is set to a power-saving mode in which power less than a reference value is used, and
wherein the direction information of the base station is identified based on identifying that the electronic device is set to the single antenna mode and the power-saving mode.

5. The electronic device of claim 1,
wherein the at least one processor is configured to identify the antenna module by identifying the antenna module corresponding to the direction information of the base station from a mapping table,
wherein the at least one processor is configured to identify the beam ID by identifying the beam ID corresponding to the direction information of the base station from the mapping table, and
wherein the at least one processor is configured to identify the polarization mode by identifying the polarization mode corresponding to the direction information of the base station from the mapping table.

6. The electronic device of claim 1,
wherein the at least one processor is configured to further identify whether network communication quality is lower than a threshold, and
wherein a single antenna mode is set based on identifying that the network communication quality is lower than the threshold.

7. The electronic device of claim 1,
wherein each first antenna element among the plurality of first antenna elements includes both a first conductive member and a second conductive member,
wherein each second antenna element among the plurality of second antenna elements includes both a third conductive member and a fourth conductive member,
wherein the first conductive member and the third conductive member receive a beam having a first polarization characteristic in a first polarization mode, and
wherein the second conductive member and the fourth conductive member receive a beam having a second polarization characteristic in a second polarization mode.

8. The electronic device of claim 1,
wherein each first antenna element among the plurality of first antenna elements is a patch antenna, and
wherein each second antenna element among the plurality of second antenna elements is a patch antenna.

9. An electronic device comprising:
at least one processor;
a first antenna module including a plurality of first antenna elements; and
a second antenna module including a plurality of second antenna elements,
wherein each of the plurality of first antenna elements is configured to receive a signal of a first polarization or a second polarization different from the first polarization,
wherein each of the plurality of second antenna elements is configured to receive a signal of the first polarization or the second polarization,
wherein the at least one processor is configured to:
identify direction information of a base station, identify, based on the direction information of the base station, an antenna module among the first antenna module and the second antenna module;
identify, based on the direction information of the base station, a beam identifier (ID);
identify, based on the direction information of the base station, a polarization mode as one of a first polarization mode or a second polarization mode; and
receive a signal based on the identified antenna module, a communication path corresponding to the identified polarization mode, and the beam ID.

10. The electronic device of claim 9,
wherein the at least one processor is configured to identify the direction information of the base station by:
identifying signal strengths in a plurality of directions, and
identifying, based on a direction of a signal having a greatest signal strength, the direction information of the base station.

11. The electronic device of claim 9, further comprising:
a grip sensor,
wherein the at least one processor is further configured to:
identify that the electronic device is gripped through the grip sensor,
identify a degree of blockage for an antenna module based on identifying that the electronic device is gripped,
identify the antenna module corresponding to the direction information of the base station and the identified degree of blockage,
identify the polarization mode corresponding to the direction information of the base station and the identified degree of blockage, and
receive a signal based on the identified antenna module, the communication path corresponding to the identified polarization mode, and the beam ID.

12. The electronic device of claim 9,
wherein the at least one processor is further configured to:
identify that the electronic device is set to a single antenna mode, and
identify that the electronic device is set to a power-saving mode in which power less than a reference value is used, and
wherein the direction information of the base station is identified based on identifying that the electronic device is set to the single antenna mode and the power-saving mode.

13. The electronic device of claim 9,
wherein the at least one processor is configured to identify the antenna module by identifying the antenna module corresponding to the direction information of the base station from a mapping table,
wherein the at least one processor is configured to identify the beam ID by identifying the beam ID corresponding to the direction information of the base station from the mapping table, and
wherein the at least one processor is configured to identify the polarization mode by identifying the polarization mode corresponding to the direction information of the base station from the mapping table.

14. The electronic device of claim 9,
wherein the at least one processor is configured to further identify whether network communication quality is lower than a threshold, and
wherein a single antenna mode is set based on identifying that the network communication quality is lower than the threshold.

15. A method performed by an electronic device, the method comprising:
identifying direction information of a base station;
identifying, based on the direction information of the base station, an antenna module among a first antenna module and a second antenna module of the electronic device;
identifying, based on the direction information of the base station, a beam identifier (ID) of the antenna module;
identifying, based on the direction information of the base station, a polarization mode of the antenna module as one of a first polarization mode or a second polarization mode; and
transmitting or receiving, by the antenna module, a signal based on the identified antenna module, a communication path corresponding to the identified polarization mode, and the beam ID.
